(19) United States
(12) Patent Application Publication
(10) Pub. No.: US 2025/0076037 A1
(43) Pub. Date: Mar. 6, 2025

(54) METHOD FOR DETERMINING THE FLATNESS OF FLEXIBLE WEB MATERIAL, METHOD FOR EVALUATING THE FLATNESS OF WEB MATERIAL, FLATNESS MEASURING ARRANGEMENT AND BLOWN FILM LINE WITH SUCH A FLATNESS MEASURING DEVICE

(71) Applicant: Kdesign GmbH, Königswinter (DE)

(72) Inventors: Richard ZIMMERMANN, Siegburg (DE); Daniel LAMERS, Königswinter (DE)

(73) Assignee: Kdesign GmbH, Königswinter (DE)

(21) Appl. No.: 18/817,769

(22) Filed: Aug. 28, 2024

(30) Foreign Application Priority Data
Aug. 29, 2023 (EP) 23193884.6

(51) Int. Cl. G01B 11/30; B65H 43/08

(52) U.S. Cl. CPC G01B 11/303; B65H 43/08; B65H 2553/41; B65H 2553/81

(57) ABSTRACT

A method for determining flatness of a flexible web material in a manufacturing process of the flexible web material includes: determining an actual flatness of the web material; determining a first process parameter of the manufacturing process; converting the actual flatness of the web material into at least one comparative value of the actual flatness of the web material depending on the first process parameter.

### CROSS-REFERENCE TO RELATED APPLICATION

This application claims priority to and the benefit of EP 23193884.6 filed on Aug. 29, 2023, the disclosure of which is incorporated herein by reference in its entirety.

### FIELD

The present disclosure relates to a method for determining flatness of flexible web material, a method for evaluating the flatness of a web material, a flatness measuring arrangement and a blown film line with such a flatness measuring arrangement.

### BACKGROUND

The statements in this section merely provide background information related to the present disclosure and may not constitute prior art.

During the extrusion of film tubes, certain recipes and products result in so-called flatness errors in the film produced. Such flatness errors are, for example, waves with any distribution, sagging in the area of the edges and so-called camber.

Such errors are clearly visible when the film is unrolled from the finished coil and rolled out on the floor without tension. Put simply, flatness errors are local length deviations of individual film areas across the web width.

These faults can often be detected visually in the film web under tension on the way from the haul-off to the winder or within the winder.

Measuring devices are known which measure the flatness of the web in the transverse direction between guide rollers on the way from the haul-off to the winder or in the winder. Furthermore, measuring devices are known which record the geometric quality of the coil as it builds up. This is intended to ensure that poor flatness quality is detected at an early stage.

Control loops are also proposed in which such measuring devices are coupled with stretching units, which are intended to improve the flatness by heating and stretching the film tube after the haul-off.

In the area of the still round film tube, heating tunnel devices are known which heat the film tube again above the frost line using infrared radiant heaters arranged in a fixed diameter in order to improve the flatness quality of the film which is later collapsed. This utilizes the effect that uneven stress distributions due to different molecular orientations on the circumference of the film tube and the resulting local length differences are reduced again by reheating, so that flatness errors in the collapsed film are significantly reduced or completely prevented.

The uneven stress distributions are mainly caused by flow effects in the extrusion die of the blow head, for example by a flow channel design that does not optimally match the raw material, by an unsuitable heating profile of the extrusion die, or by an uneven circumferential temperature distribution and/or circumferential volume distribution of the melt inside and at the outlet from the extrusion die.

In addition, a calibration basket that is set at a height that does not match the frost line of the film tube, excessive contact pressure (filling level) in the calibration basket or a calibration basket that is slightly off-center in relation to the extrusion die can also cause flatness errors.

A method for determining the flatness of films is known from EP 3 504 043 A1, in which the flatness is to be determined at the same tensile stress so that directly comparable determination results are obtained. The flatness is determined in particular in web sections in which the web tension is zero or close to zero in order to minimize the influence on the flatness of the film for the purpose of measurement. The disadvantage of this method is that the control of very small web tension requires very cost-intensive control technology and the maximum conveying speeds in these areas are limited as a result. In addition, a regulation for very small web tension proves to be less stable or susceptible to faults, which can lead to an increase in downtimes.

### SUMMARY

This section provides a general summary of the disclosure and is not a comprehensive disclosure of its full scope or all of its features.

According to one aspect, the object is to provide a simple method for determining the flatness in a manufacturing process of a flexible web material and a simple method for evaluating the flatness of web material. According to another aspect the object is to provide a flatness measuring arrangement and a blown film line with such a flatness measuring arrangement, each of which enables one of the methods described above.

To achieve these objects, a method for determining the flatness in the manufacturing process of flexible web material is proposed, comprising the steps: determining an actual flatness of the web material; determining a first process parameter of the manufacturing process; and converting the actual flatness of the web material into at least one comparative value of the actual flatness of the web material depending on the first process parameter.

The actual flatness of the web material can, for example, be defined by the actual topography of one or more surfaces of the web material. The surface under consideration can be the top and/or bottom side of the web material. The actual topography describes the determined geometric shape of the technical surface of the flexible web material. In this respect, in a possible embodiment of the method for determining the actual flatness of the web material, an actual topography of one or more surfaces of the web material can be determined. Therefore, when the determination of the actual flatness of the web material is generally referred to below, the specific embodiment of the determination of the actual topography of a surface of the web material should also be disclosed.

In a further possible embodiment, the first process parameter of the manufacturing process can be a web tension of the web material. The web tension can either be described by the tensile force acting on the flexible web material in a transport direction of the web material. The web tension of the web material can be determined as a process parameter by means of a web tension unit. The web tension unit can be designed to measure the web tension. The measured web tension can also be referred to as the actual web tension. The web tension unit can also be designed to adjust the web tension to the web material, at least in sections. However, it is also conceivable that the target web tension of the web material is specified to determine the web tension of the web material. For this purpose, the target web tension of the web material can be taken from the production specifications, for example.

It is understood that the present disclosure is not limited to an embodiment with the web tension as the first process parameter. Rather, it is also conceivable in principle that the first process parameter is selected from the group of further process parameters mentioned below.

In a possible embodiment, the at least one comparative value of the actual flatness of the web material can be a comparative flatness. In particular, the at least one comparative value of the actual flatness of the web material can be a comparative topography. This can be the case, for example, if an actual topography of one or more surfaces of the web material is determined to determine the actual flatness of the web material. It is also conceivable that the at least one comparative value of the surface of the web material is a characteristic value characterizing the actual topography, for example the standard deviation, the coefficient of variation, the Pearson skewness, the curvature and the excess, the mean deviation, the Abbott curve and/or the profile depth of the actual topography.

In a further possible embodiment, the method can comprise the determination of at least one further process parameter of the manufacturing process. The at least one further process parameter can, for example, be selected from the group of process parameters including a width of the web material, a thickness of the web material, a material composition of the web material, a temperature of the web material and an ambient temperature of the web material.

As explained above, it is understood that the other process parameters mentioned above can also serve as the first process parameter. In this case, the web tension can serve as at least one further process parameter.

The width of the web material can be determined as a process parameter by means of a web width measuring arrangement. The web width measuring arrangement can be any tactile or non-contact measuring system known to the person skilled in the art, which is designed to determine the width of the web material. The width of the web material can be determined once or at one measuring point, several times or at several measuring points, or continuously. However, it is also conceivable that the target width of the web material is used to determine the width of the web material. The target width of the web material can be taken from the production specifications or customer requirements, for example.

The thickness of the web material can be determined as a process parameter using a web thickness measuring arrangement. The web thickness measuring arrangement can be any tactile or non-contact measuring system known to the person skilled in the art, which is designed to determine the thickness of the web material. The thickness of the web material can be determined once or at one measuring point, several times or at several measuring points, or continuously. However, it is also conceivable that the target thickness of the web material is used to determine the thickness of the web material. The target thickness of the web material can be taken from the production specifications or customer requirements, for example.

Determining a material composition of the web material as a process parameter can be done in particular by determining the target material composition, for example from production specifications or customer requirements. The web material can comprise one or more layers of materials that are bonded together. The material composition of the web material may include a description of the number of layers of the web material and the material used in each layer. In this respect, the material composition can also be described as a recipe. It is also conceivable that the material composition of the web material is determined by means of a material testing arrangement that is designed to determine the material composition of the web material. The material composition of the web material can be determined once or at one measuring point, several times or at several measuring points, or continuously.

After determining a material composition of the web material, at least one material characteristic value of the web material can be determined depending on the material composition. The properties of the individual layers of the web material can be summarized in the at least one material characteristic value. The material parameters that can be considered are, in particular, the tensile strength, which can also be referred to as the breaking strength, the elongation at break, which can also be referred to as the elongation at rupture, the modulus of elasticity, the creep modulus and the density. The Melt Flow Index (MFI) can also be considered as a material parameter. It goes without saying that the material characteristic value can also serve as the first process parameter.

The temperature of the web material can be determined as a process parameter using a temperature measuring arrangement. The temperature measuring arrangement can be any tactile or non-contact measuring system known to the skilled person, which is designed to determine the temperature of the web material. The temperature of the web material can be determined once or at one measuring point, several times or at several measuring points, or continuously. However, it is also conceivable that the target temperature of the web material is used to determine the temperature of the web material. The target temperature of the web material can be taken from the production specifications, for example.

The ambient temperature can be determined by a further temperature measuring arrangement. It is also conceivable that a temperature measuring arrangement determines both the temperature of the web material and the ambient temperature.

In a further possible embodiment, the determination of the actual flatness of the web material and/or the determination of the process parameters can take place in a detection area between a first roller and a second roller. The web material is guided over the first roller and the second roller. In particular, the first and second rollers can be elements of a collapsing unit, a main haul-off, an intermediate haul-off, a stretching unit, a pre-haul-off in a winding arrangement, an auxiliary haul-off in the winding arrangement or the winding station. The first roller and the second roller can be arranged downstream of one another in a transport direction of the web material and can thus be arranged at a distance from one another in the transport direction of the web material.

The actual flatness of the web material can be determined using a flatness measuring unit. In particular, the flatness measuring unit can be designed to determine the actual topography of a surface of the web material. The actual flatness of the web material can be determined in a transverse plane of the web material. Alternatively or in combination, the actual flatness of the web material can be determined by means of a flatness measuring unit arranged in the transverse plane of the web material. The transverse plane can be aligned transversely, in particular orthogonally, to the transport direction of the web material and is referred to as the measurement plane.

In a possible embodiment, the flatness measuring unit can comprise a measuring beam that is arranged transversely, in particular orthogonally, to the transport direction of the web material. The measuring beam can capture a measuring track on the web material that extends straight from one longitudinal side to the other longitudinal side of the web material. In other words, the measuring beam can determine the surface profile in a transverse plane of the web material.

In a further possible embodiment, it is conceivable that the flatness measuring unit comprises a traversing measuring system that can be moved on a carrier element between a first end position and a second end position. The measuring system can also be referred to as a measuring slide. The carrier element can be arranged transversely, in particular orthogonally, to the transport direction of the web material. The end positions can each overlap with a longitudinal side of the web material in the transverse plane or be at a greater distance from each other than the width of the web material. This allows the flatness or the actual topography to be determined over the entire width of the web material. While the measuring system is moving on the carrier element, the measuring system detects the surface of the web material at a measuring point or on a measuring surface, whereby the measuring point or the measuring surface is moved across the width of the web material. The measuring point can be recorded continuously, quasi-continuously or point by point. The movement of the web material in the transport direction results in a measuring track on the surface of the web material, which is wave-shaped and, at a constant traversing speed of the measuring system, in particular zig-zag-shaped. The actual flatness of the web material can be determined in sections or continuously along the web material.

The flatness measuring unit can also be designed so that the width of the web material is also determined as a process parameter by means of the flatness measuring unit.

The first process parameter and/or the at least one further process parameter can be determined in the transport direction of the web material in the area of the transverse plane.

The method can comprise a further method step of determining the distance between the first roller and the second roller. The distance between the first roller and the second roller can be defined by the distance between the two axes of rotation of the first roller and the second roller. In this case, the distance between the first roller and the second roller can, for example, be taken from the design drawings of the system used for the process or be measured. Alternatively, the distance between the first roller and the second roller can be defined by the release point of the web material from the first roller and the infeed point of the web material on the second roller. The release point is defined as the last point at which the web material is in contact with a roller in the transport direction. The infeed point is defined as the point where the web material first comes into contact with a roller in the transport direction. In this case, the distance between the first roller and the second roller can be calculated, for example, using the design data of the system used for the process, in particular from the center distance of the two rollers and their respective diameters.

The method can comprise a further method step of determining a distance between the first roller and the flatness measuring unit. The distance between the first roller and the flatness measuring unit can be defined by the distance between the release point of the web material from the first roller and the cutting line, which is defined by the web material and the measurement plane, in the transport direction. If the transverse plane is not orthogonal to the transport direction, the relevant distance can be, for example, the shortest, an average or the largest distance between the release point of the web material from the first roller and the cutting line in the transport direction, as the distance varies over the width of the web material.

In a further possible embodiment, the conversion of the actual flatness into at least one comparative value of the actual flatness can additionally take place depending on at least one of the further process parameters including a width of the web material, a thickness of the web material, a material composition of the web material, a temperature of the web material, an ambient temperature, a distance between the first roller and the second roller, a distance between the first roller, a distance between the second roller and the flatness measuring unit and/or depending on the at least one material characteristic value.

In a further possible embodiment, the method can comprise the determination of a reference value of the first process parameter as a further method step. Determining one of the above-mentioned process parameters results in an amount or actual value of the process parameter. The reference value corresponds to a fixed amount or value that is used for the relative classification of the determined amount or value of the process parameter. For example, the first process parameter can be the web tension of the web material and the reference value of the first process parameter can be a reference web tension. A value of 50 N to 150 N is particularly suitable as a reference web tension.

The conversion of the actual flatness into the at least one comparative value of the actual flatness can take place depending on the reference value of the first process parameter and/or the determined first process parameter. In other words, the previously determined actual flatness can be converted into the at least one comparative value of the actual flatness, whereby the reference value of the first process parameter and/or the determined first process parameter can be used for the conversion.

The reference value of the first process parameter can be determined depending on at least one of the other process parameters selected from the group comprising width of the web material, thickness of the web material, material composition of the web material, temperature of the web material, ambient temperature and the distance between the first roller and the second roller, distance between the first roller and the flatness measuring unit and/or depending on the at least one material parameter.

The reference value of the first process parameter can therefore be represented by a value that is independent of the web material or by a value that is depending on the web material. In both cases, the reference value of the first process parameter can be used to ensure comparability between individual measurement results on the same or different web materials.

In another possible embodiment, the web tension can be determined in the transport direction of the web material in the area of the transverse plane. The area between the release point of the web material from the first roller and the infeed point of the web material onto the second roller can be referred to as the detection area. It is clear to the person skilled in the art that the web tension in the transport direction can be assumed to be constant in the detection area. In this respect, it is also conceivable that the web tension can be determined in the transport direction of the web material outside the transverse plane. In particular, it is conceivable that the web tension is determined in the transport direction of the web material in the detection area.

To solve the problem, a method for evaluating the flatness of web material is also proposed, comprising: the method for determining the flatness in the manufacturing process of flexible web material according to a previously described embodiment, and the method step: Converting the at least one comparative value of the actual flatness of the web material into at least one quality parameter of the flatness.

The quality parameter is a characteristic value that summarizes the quality with regard to one or more quality aspects of the flatness. The quality of the flatness can therefore be easily deduced from at least one quality parameter of the flatness.

In particular, it is conceivable that the at least one comparative value is converted into exactly one quality parameter of the flatness. In this case, the flatness can be represented holistically in a parameter in order to be able to evaluate the quality of the manufacturing process. It is also conceivable that the at least one comparative value is converted into several quality parameters of the flatness in order to be able to evaluate the quality of various aspects of the manufacturing process. For example, one quality parameter can evaluate the bagginess of the web material and another quality parameter can evaluate the camber of the web material. The quality parameter can, for example, have a value between 0 (low quality) and 100 (high quality), be designed in the form of a school grading system or as a traffic light system.

The conversion of the at least one comparative value into the at least one quality parameter of the flatness can, in the case in which the at least one comparative value of the actual flatness of the web material is a comparative topography, be carried out using one of the methods of determining the standard deviation, determining the coefficient of variation, determining the Pearson skewness, determining the camber and the excess, determining the mean deviation, determining the Abbott curve and/or determining the profile depth of the comparative topography.

To solve the problem, a flatness measuring arrangement for web material is further proposed, comprising: a flatness measuring unit which is designed to determine an actual flatness of the web material in the detection section of the web material, a web tension unit which is designed to determine the web tension in the detection section of the web material, and an evaluation unit which is designed to convert the actual flatness into at least one comparative value of the actual flatness of the web material depending on the web tension.

In particular, the flatness measuring unit can be designed to determine an actual topography of a surface of the web material in the detection section of the web material in order to determine the actual flatness of the web material.

The flatness measuring arrangement can be particularly suitable for measuring the flatness of a plastic web.

The flatness measuring arrangement can be designed to carry out a method of the type described above. In this respect, the flatness measuring arrangement can comprise elements that are designed to carry out the method steps described above, whereby reference is made here to the explanations above for brevity.

The web tension unit can comprise a web tension sensor that detects or measures the web tension in the detection section of the web material. Alternatively, the web tension unit can have an interface via which the web tension unit receives data about the web tension from an external control unit. The external control unit can in particular be a control unit of a blown film line in which the flatness measuring arrangement is used.

The web tension unit can also be designed in such a way that it can apply and/or fix a web tension to the web material in the detection section. The web tension unit can, for example, comprise a pair of haul-off rollers, between which a gap is formed through which the web material is fed. One or both haul-off rollers can be rubberized.

The evaluation unit can be connected to the flatness measuring unit and the web tension unit so that the evaluation unit can receive data on the actual flatness or actual topography and the web tension.

In a possible embodiment, the flatness measuring arrangement can comprise a module frame. The flatness measuring unit, the web tension unit and/or the evaluation unit can be attached to the module frame. The module frame enables easy integration of the flatness measuring arrangement into existing blown film lines.

To solve the problem, a blown film line is further proposed, comprising: a blow head for ejecting a film tube, a collapsing unit for folding the film tube into a web material, a flatness measuring arrangement according to a previously described embodiment.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic representation of a blown film line;

FIG. 2 is a schematic side view of the detection section of the blown film line from FIG. 1;

FIG. 3 is a schematic top view of the detection section of the blown film line from FIG. 1;

FIG. 4 is a first alternative configuration of the winding arrangement of the blown film line shown from FIG. 1;

FIG. 5 is a second alternative configuration of the winding arrangement of the blown film line from FIG. 1;

FIG. 6 is a flow chart of a method for determining the flatness of flexible web material; and

FIG. 7 is a flow chart of a method for evaluating the flatness of web material.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

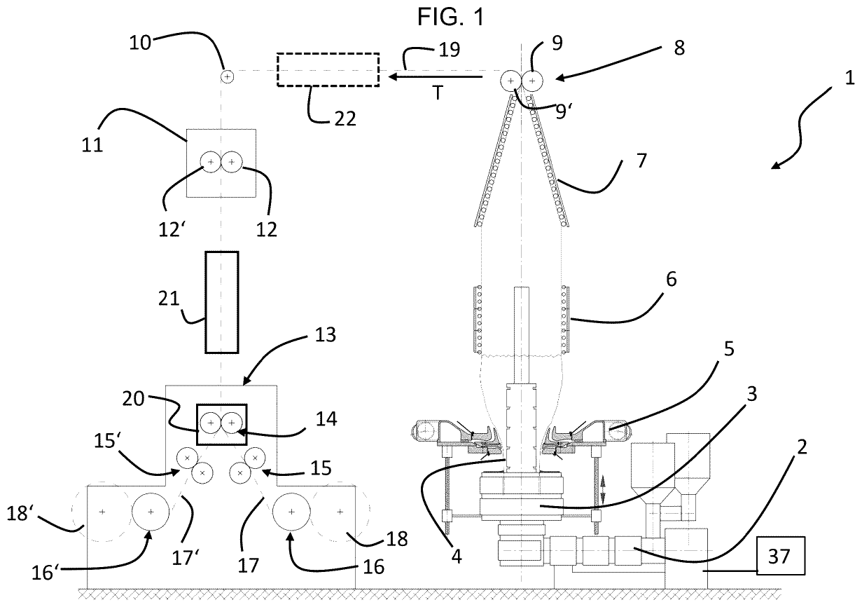

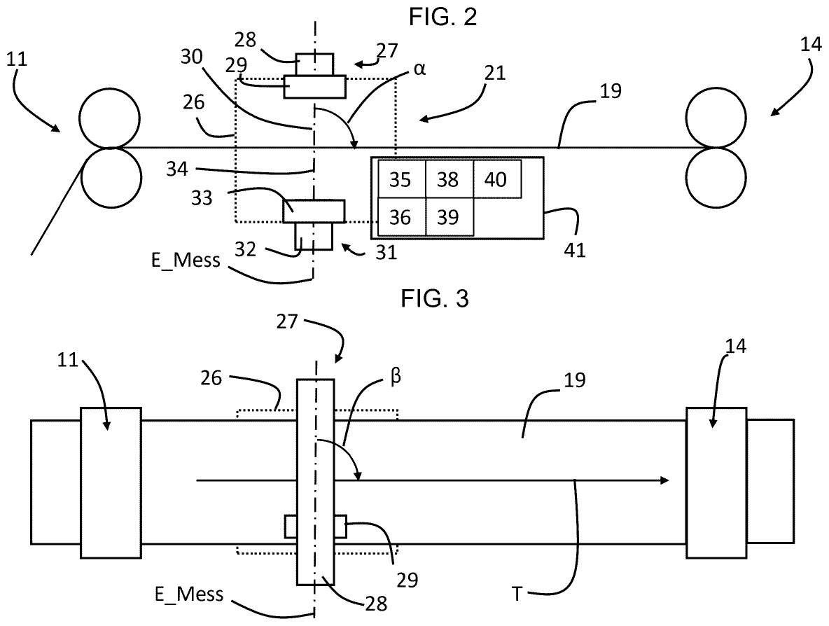

FIGS. 1 to 3, which are described together below, show a blown film line 1 which is designed for the production of flexible web material and is controlled by a control unit 37. In this case, the flexible web material is a plastic film 17, 17′. The blown film line 1 comprises an extruder 2 for plasticizing and transporting a plastic towards a blow head 3. The blow head 3 comprises an annular opening from which the plasticized plastic is ejected, forming a plastic tube 4. The plastic tube 4 runs into a cooling ring 5 that cools and solidifies the plastic tube 4 in a manner known to the skilled person. The plastic tube 4 then runs into a calibration device 6 for calibrating the diameter of the plastic tube 4. After diameter calibration, the plastic tube 4 is folded in a collapsing unit 7 to form a double plastic web, which can also be referred to as web material 19.

The web material 19 is then fed into a main haul-off 8. The main haul-off 8 has a first roller 9 and a second roller 9′, which form a gap through which the web material 19 runs. The first roller 9 and the second roller 9′ can also be referred to as squeeze rollers. The main haul-off 8 is designed to apply a web tension to the plastic tube 4.

After the main haul-off 8, the web material 19 is guided in a transport direction T over a deflection roller 10 and fed to an intermediate haul-off 11. The intermediate haul-off 11 has a first roller 12 and a second roller 12′, which form a gap through which the web material 19 runs. The intermediate haul-off 11 is designed to apply a web tension to the web material 19, in particular in the first web material area between the main haul-off 8 and the intermediate haul-off 11.

Alternatively or in combination with the intermediate haul-off 11, the blown film line 1 can comprise a stretching device in which the web material 19 is heated and stretched over one or more rollers in order to achieve a desired stretching ratio.

The blown film line 1 also comprises a winding arrangement 13, in which a first plastic film 17 and a second plastic film 17′ are each wound onto an associated film coil 18, 18′. The plastic films 17, 17′ can also be referred to as web material. The winding arrangement 13 has a pre-haul-off 14 with two rollers, by means of which a web tension can be applied to the web material 19, in particular in the second web section between the intermediate haul-off 11 or the stretching device and the pre-haul-off 14. In the present case, the double-layered web material 19 enters the pre-haul-off 14 and is separated into the two plastic films 17, 17′ by means of a severing device 20 after exiting the pre-haul-off 14. Such severing devices 20 are known to those skilled in the art.

The plastic films 17, 17′ are each wound onto the respective film coils 18, 18′ via a contact roller 16, 16′. The contact roller 16, 16′ is in direct contact with the respective film coil 18, 18′ and ensures that the plastic films 17, 17′ are guided on the respective film coils 18, 18′. The contact rollers 16, 16′ can apply a web tension to the plastic films 17, 17′, in particular in a third web section between the pre-haul-off 14 and the respective contact roller 16, 16′.

Between the pre-haul-off 14 and the contact rollers 16, 16′, an auxiliary haul-off 15, 15′ can optionally be arranged, which has two rollers by means of which a web tension can be applied to the plastic films 17, 17′, in particular in a fourth web section between the pre-haul-off 14 and the respective auxiliary haul-off 15, 15′.

The blown film line 1 comprises a first flatness measuring arrangement 21, which is designed to determine an actual flatness of the web material 19 in the second web section. Specifically, the first flatness measuring arrangement 21 determines an actual topography of the web material 19, which represents the actual flatness of the web material. In this respect, the second web section can also be referred to as the second detection section. The first flatness measuring arrangement 21 comprises a first flatness measuring unit 27 for determining the actual topography of a first surface of the double-layered web material 19. The first surface can also be referred to as the top side. The first flatness measuring unit 27 comprises a support beam 28 on which a measuring slide 29 is displaceably mounted. The measuring slide 29 comprises a laser that scans the topography of the first surface of the web material 19 with a laser beam 30.

The measuring slide 29 traverses continuously back and forth on the support beam 28 between a first end position and a second end position. The laser beam 30 is thus moved in a measurement plane E_Mess. The first end position and the second end position are arranged in the measurement plane E_Mess in overlap with the longitudinal sides of the web material 19 or beyond. In the present case, the measurement plane E_Mess is arranged orthogonally to the surface and the transport direction of the web material 19. However, it is also conceivable that the measurement plane E_Mess is arranged at an angle α to the surface of the web material 19 that deviates from 90 degrees. Alternatively or in combination, it is conceivable that the measurement plane E_Mess is arranged at an angle β to the transport direction of the web material 19 that deviates from 90 degrees. The angle β is arranged around a normal to the surface of the web material 19. The measurement plane E_Mess can therefore also be described as a transverse plane.

The first flatness measuring unit 27 detects the topography of the web material 19 along a measuring track defined by the intersection of the laser beam 30 and the surface of the web material 19. Due to the traversing of the measuring slide 29 on the support beam 28, the measuring track in this case is a wavy line, which can also be described as a zigzag line.

It is also conceivable that the flatness measuring unit does not comprise a traversing measuring slide, but a measuring beam with several fixed measuring means, in particular measuring lasers. In this case, the measuring track is made up of straight lines defined by the intersection of the measurement plane E_Mess with the surface of the web material 19.

The first flatness measuring arrangement 21 also comprises a second flatness measuring unit 31 for determining the actual topography of a second surface of the web material 19. The second surface can also be referred to as the bottom side of the web material 19. The second flatness measuring unit 31 comprises a support beam 31 and a measuring slide 32 and is designed in the same way as the first flatness measuring unit 27. In this respect, what was previously said in the context of the first flatness measuring unit 27 also applies to the second flatness measuring unit 31.

The first flatness measuring arrangement 21 further comprises a web tension unit 35 with an interface via which the web tension unit 35 receives data about the web tension from the control unit 37 of the blown film line 1.

The first flatness measuring arrangement 21 further comprises an evaluation unit 36, which converts the actual topographies determined by the first flatness measuring unit 27 and the second flatness measuring unit 31 into a comparative value of the actual flatness or the actual topographies of the respective surface of the web material 19 depending on the web tension determined by the web tension unit 35.

The first flatness measuring arrangement 21 further comprises a web width measuring arrangement 38 configured to measure a width of the web material 19 in the detection area, a web thickness measuring arrangement 39 configured to measure a thickness of the web material 19 in the detection area, and a temperature measuring arrangement 40 configured to measure the surface temperature of the web material 19 on the top side and/or the bottom side and an ambient temperature.

The first flatness measuring arrangement 21 comprises a module frame 26, shown schematically, in which the flatness measuring units 27, 31, the web tension unit 35, the evaluation unit 36, the web width measuring arrangement 38, the web thickness measuring arrangement 39 and the temperature measuring arrangement 40 are mounted. With the module frame 26, the flatness measuring arrangement 21 can be easily integrated into existing blown film lines.

The blown film line 1 has an optional second flatness measuring arrangement 22, which is designed to determine an actual flatness or an actual topography of the web material 19 in the first web section between the main haul-off 8 and the intermediate haul-off 11. The second flatness measuring arrangement 22 can be constructed in the same way as the first flatness measuring arrangement 21, so that what was previously said in the context of the first flatness measuring arrangement also applies to the second flatness measuring arrangement 22.

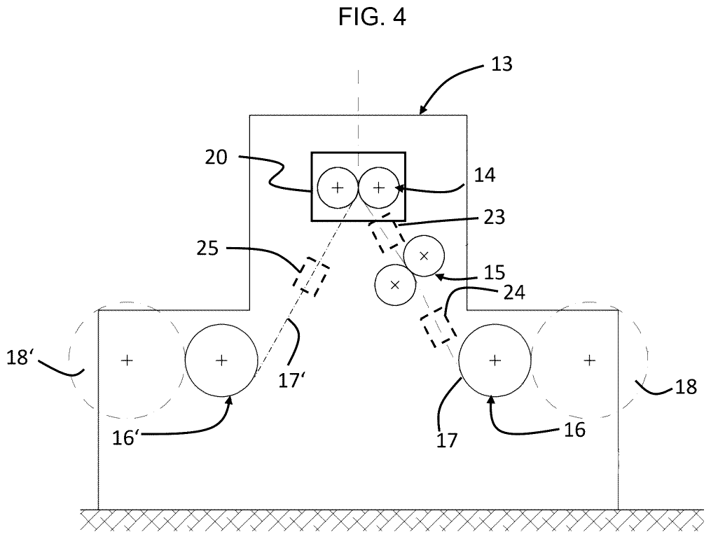

FIG. 4 shows an alternative configuration of the winding arrangement 13. This differs from the configuration shown in FIG. 1 in that only the first plastic film 17 is additionally guided to the pre-haul-off 14 and to the contact roller 16 via an auxiliary haul-off 15. The second plastic film 17′, on the other hand, is only guided over the pre-haul-off 14 and the contact roller 16, so that a third web section is defined between the pre-haul-off 14 and the contact roller 16.

The winding arrangement 13 of FIG. 4 comprises an optional third flatness measuring arrangement 23, which is designed to determine an actual flatness or actual topography of the plastic film 17 in the fourth web section. The winding arrangement 13 comprises an optional fourth flatness measuring arrangement 24, which is designed to determine an actual flatness or actual topography of the plastic film 17 in a fifth web section between the contact roller 16 and the auxiliary haul-off 15. The winding arrangement 13 comprises an optional fifth flatness measuring arrangement 25, which is designed to determine an actual flatness or actual topography of the plastic film 17′ in the third web section between the contact roller 16′ and the pre-haul-off 14.

The third, fourth and fifth flatness measuring arrangements 23, 24, 25 can be constructed analogously to the first flatness measuring arrangement 21, so that what was previously said in the context of the first flatness measuring arrangement also applies to these flatness measuring arrangements. It is also conceivable that the third, fourth and fifth flatness measuring arrangements 23, 24, 25 comprise only one flatness measuring unit and that the second flatness measuring unit is omitted.

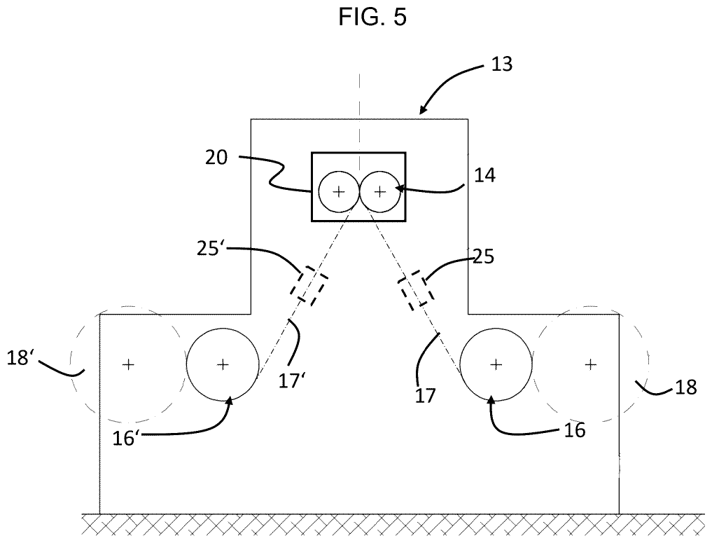

FIG. 5 shows a further alternative configuration of the winding arrangement 13. This differs from the embodiment of FIG. 1 in that the first plastic film 17 and the second plastic film 17′ are only guided over the pre-haul-off 14 and the respective contact roller 16, 16′, whereby a third web section is defined in each case between the pre-haul-off 14 and the respective contact roller 16, 16′.

The winding arrangement 13 of FIG. 4 comprises an optional fifth flatness measuring arrangement 25, which is designed to determine an actual flatness or actual topography of the plastic film 17 in the third web section. The winding arrangement 13 comprises a further optional fifth flatness measuring arrangement 25′, which is designed to determine an actual flatness or actual topography of the plastic film 17′ in the further third web section.

The fifth flatness measuring arrangements 25, 25′ can be constructed analogously to the first flatness measuring arrangement 21, so that what was previously said in the context of the first flatness measuring arrangement also applies to these flatness measuring arrangements. It is also conceivable in this case that the fifth flatness measuring arrangements 25, 25′ comprise only one flatness measuring unit and that the second flatness measuring unit is dispensed with.

The first flatness measuring arrangement 21 comprises a module control unit 41, which communicates with the control unit 37 and controls the first flatness measuring arrangement 21. It is understood that each of the flatness measuring arrangements can have a separate module control unit 41 or that a module control unit 41 is provided which controls all the flatness measuring arrangements together.

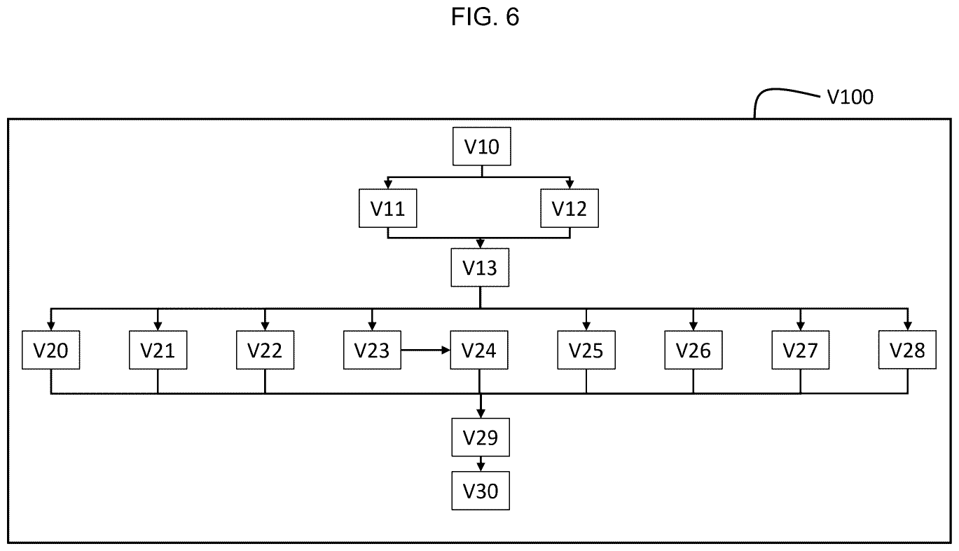

FIG. 6 shows a method V100 according to the disclosure for determining the flatness of flexible web material using a flow chart. The method can be carried out by the blown film line 1 described above and by the flatness measuring arrangements 21, 22, 23, 24, 25, 25′ used therein.

In a first method step V10, the actual flatness is determined via the actual topography of a surface of a web material 19, 17, 17′ in one or more detection areas by means of at least one of the flatness measuring arrangements 21, 22, 23, 24, 25, 25′. The actual flatness or actual topography is determined in a detection area between a first roller and a parallel second roller over which the web material is guided. The first and second rollers can in particular be rollers of the main haul-off 8, the intermediate haul-off 11, the optional stretching unit, the pre-haul-off 14 in the winding arrangement 13, the auxiliary haul-off 15, 15′ in the winding arrangement 13 or the contact rollers 16, 16′. In an optional method step V11, the deflection of the support beam 28, 32 is determined depending on the measurement position over the width of the support beam. In a further optional method step V12, an offset of the measuring beam relative to an ideal web plane is determined depending on the measurement position over the width of the support beam. The ideal web plane is the plane that is tangential to both the first roller and the second roller. Interlacing should be understood as the deviation of the distance between the support beam 28, 32 and the ideal web plane and an average distance. In a further optional method step V13, a correction profile is determined from the deflection and the interlacing of the support beam 28. Method steps V11, V12 and V13 can either be carried out with a reference run upstream of process V100 or during the execution of process V100.

In a further method step V20, a first process parameter is determined in the respective detection area. In this case, the actual web tension is measured as the first process parameter. This is done by means of the web tension unit 35 of the respective flatness measuring arrangement 21, 22, 23, 24, 25, 25′.

The procedure includes the optional method steps: (V21) determining a width of the web material, in particular by measuring an actual width of the web material by means of the web width measuring arrangement 38; (V22) determining a thickness of the web material, in particular by measuring an actual thickness of the web material by means of the web thickness measuring arrangement 39; (V23) determining a material composition of the web material; (V24) determining at least one material characteristic value of the web material depending on the material composition determined in method step V23; (V25) determining a temperature of the web material, in particular by measuring an actual surface temperature of the web material by means of the temperature measuring arrangement 40; (V26) determining an ambient temperature by means of the temperature measuring arrangement 40; (V27) determining the distance between the first roll and the second roll; and (V28) determining a distance between the first roll and the flatness measuring unit.

As a further optional method step V29, the method comprises determining a reference value of the first process parameter. Since the first process parameter in this case is the web tension, the reference value can also be referred to as the reference web tension. The reference value can be determined depending on at least one of the previously determined values or further process parameters including a width of the web material, a thickness of the web material, a material composition of the web material, a temperature of the web material, an ambient temperature, a distance between the first roller and the second roller, a distance between the first roller and the flatness measuring unit and/or depending on the at least one material characteristic value.

Subsequently, in a method step V30, the actual flatness determined in method step V10 is converted into at least one comparative value of the actual flatness of the web material depending on the first process parameter. In the present case, the actual topography of the surface of the web material represents the actual flatness, so that the actual topography of the surface of the web material is converted into at least one comparative value of the actual topography of the web material. In this case, the comparative value of the actual topography of the web material is a comparative topography. The comparative topography is determined by rescaling the actual topography depending on the first process parameter, in this case depending on the web tension. Consequently, the relative position of the local minima and maxima of the two topographies in the transport direction remains identical, but the absolute value of the local minima and maxima is changed. In other words, the actual topography is stretched or compressed in the height direction in order to arrive at the comparative topography.

Optionally, the conversion of the actual flatness into at least one comparative value of the actual flatness of the web material, in particular into the comparative topography, can additionally be performed depending on at least one of the values including width of the web material, thickness of the web material, material composition of the web material, temperature of the web material, ambient temperature, distance between the first roller and the second roller, distance between the first roller and the flatness measuring unit and/or depending on the at least one material characteristic value. As an additional option, the actual flatness can be converted into the at least one comparative value depending on the reference value, in this case depending on the reference web tension, and/or the first process parameter, in this case depending on the web tension. As a further additional option, the actual topography can be corrected with the previously created correction profile before converting the actual flatness into at least one comparative value.

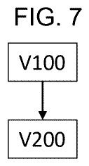

FIG. 7 shows a method for evaluating the flatness of a web material using a flow chart. The method comprises the previously described method V100 for determining the flatness of flexible web material, as well as method step V200: conversion of the comparative value into at least one quality parameter of the flatness. In the method step, the comparative values of a flatness measuring arrangement or several parallel flatness measuring arrangements can be converted into at least one common quality parameter of the flatness.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for determining flatness of a flexible web material in a manufacturing process of the flexible web material, the method comprising steps of:
determining an actual flatness of the web material,
determining a first process parameter of the manufacturing process,
converting the actual flatness of the web material into at least one comparative value of the actual flatness of the web material depending on the first process parameter.

2. The method according to claim 1, wherein an actual topography of a surface of the web material is determined in order to determine the actual flatness of the web material.

3. The method according to claim 1, wherein the first process parameter of the manufacturing process is a web tension of the web material.

4. The method according to claim 1, wherein the at least one comparative value of the actual flatness of the web material is a comparative flatness or a comparative topography.

5. The method according to claim 1, further comprising:
determining at least one further process parameter of the manufacturing process, wherein the at least one further process parameter is one of process parameters including a width of the web material, a thickness of the web material, a material composition of the web material, a temperature of the web material and an ambient temperature.

6. The method according to claim 5, wherein conversion of the actual flatness of the web material into the at least one comparative value of the actual flatness of the web material is additionally carried out depending on the at least one further process parameter and/or at least one material characteristic value.

7. The method according to claim 1, further comprising:
defining a reference value for the first process parameter, wherein the actual flatness of the web material is converted into the at least one comparative value of the actual flatness of the web material based on the reference value of the first process parameter.

8. The method according to claim 7, wherein the first process parameter is a web tension of the web material,
wherein the reference value of the first process parameter is a reference web tension, and
wherein the reference value of the first process parameter depends on at least one further process parameter and/or the at least one material parameter.

9. The method according to claim 1, wherein the actual flatness of the web material is determined in a transverse plane of the web material, and/or the actual flatness of the web material is determined by means of a flatness measuring unit which is arranged in the transverse plane of the web material, and
wherein the transverse plane is orientated transversely, in particular orthogonally, to a transport direction of the web material.

10. The method according to claim 9, wherein the first process parameter and/or at least one further process parameter is determined in the transport direction of the web material in a region of the transverse plane.

11. A method for evaluating flatness of a web material, comprising the steps according to claim 1, and a step of converting the at least one comparative value of the actual flatness of the web material into at least one quality parameter of the flatness.

12. The method according to claim 11, wherein the at least one comparative value of the actual flatness of the web material is a comparative topography, and
wherein the at least one comparative value is converted into the at least one quality parameter of the flatness by using at least one method selected from a group consisting of determining a standard deviation, determining a coefficient of variation, determining Pearson skewness, determining camber and excess, determining a mean deviation, determining an Abbott curve and determining a profile depth of the comparative topography.

13. A flatness measuring arrangement for a web material, in particular for a plastic web, comprising:
a flatness measuring unit which is configured to determine an actual flatness of the web material, in particular an actual topography of a surface of the web material, in a detection section of the web material;
a web tension unit adapted to detect a web tension in the detection section of the web material; and
an evaluation unit which is configured to convert the actual flatness into at least one comparative value of the actual flatness of the web material depending on the web tension.

14. The flatness measuring arrangement according to claim 13, further comprising a module frame in which one or more of elements of the flatness measuring unit, the web tension unit and the evaluation unit are mounted.

15. A blown film line comprising:
a blow head for ejecting a film tube,
a collapsing unit for folding the film tube into a web material,
the flatness measuring arrangement according to claim 13.
